(19) United States
(12) Patent Application Publication
(10) Pub. No.: US 2007/0194033 A1
(43) Pub. Date: Aug. 23, 2007

(54) QUICK OPENING AND CLOSING LID FOR PIG CHAMBERS, WITH A SAFETY VALVE

(76) Inventor: Antonio Tadeu Dos Santos Junior, Barros Reis (BR)

Correspondence Address: RICHARD M. GOLDBERG, 25 EAST SALEM STREET, SUITE 419, HACKENSACK, NJ, 07601, US

(21) Appl. No.: 11/614,653

(22) Filed: Dec. 21, 2006

(30) Foreign Application Priority Data
Feb. 17, 2006 (BR) PI 0600444-0

(51) Int. Cl. A21B 1/08

(52) U.S. Cl. 220/912; 126/20

(57) ABSTRACT

A quick opening and closing lid for pig chambers, with safety valve, includes a screw (6) with a needle type seal that traverses the two holes (5) in the clamps (3) and penetrates the hole (5) in the upper part of the mouth (2) of the pressure receptacle, thereby preventing the internal pressure from escaping and locking the clamps (3) that secure the lid (1) that seals the mouth (2). In order to open the pressure receptacle, screw (6) is unscrewed to allow the pressure to escape through the hole (5). With the receptacle depressurized, screw (6) is removed, thereby releasing the clamps (3) and consequently allowing the lid (1) to be opened.

This Patent of Invention describes a hinged quick opening and closing lid for PIG chambers, having a drive system, a lever and a plate clamp, capable of being operated within a few seconds with minimal effort. It also has a pressure indicator valve that impedes the lid from being opened while there is pressure and from being closed before this valve is closed. These chambers are designed for cleaning, product separation, removal of liquids, and visual inspection.

There are various quick opening and closing designs: some lock the lid through the expansion of a number of lever-driven circumferential segments attached to the outer face of the lid and connected to each other by linkage; in other designs, the lid is locked conversely, as two or more circumferential segments fixed to the mouth of the pressure receptacle, and not directly on the lid as in the previous example, instead of opening, close over the circumference of the lid and the mouth of the pressure receptacle, thereby securing the two and providing a complete seal.

The novelty of this invention is the use of a pressure indicator safety valve, which makes it impossible to open the lid while there is pressure inside the pipe or recipient, and also impedes the lid from being shut without first shutting off the safety valve. The safety valve and pressure indicator, which basically consists of a screw with a needle type seal, is installed on the body of the lid, locking the clamp and preventing the lid from being opened. Made of special steel alloy, with high mechanical strength and corrosive resistance, it is screwed and welded to the body of the lid, and its operation is simplified because it can be operated using a common tool.

In the diagrams that accompany and are part of the present description,

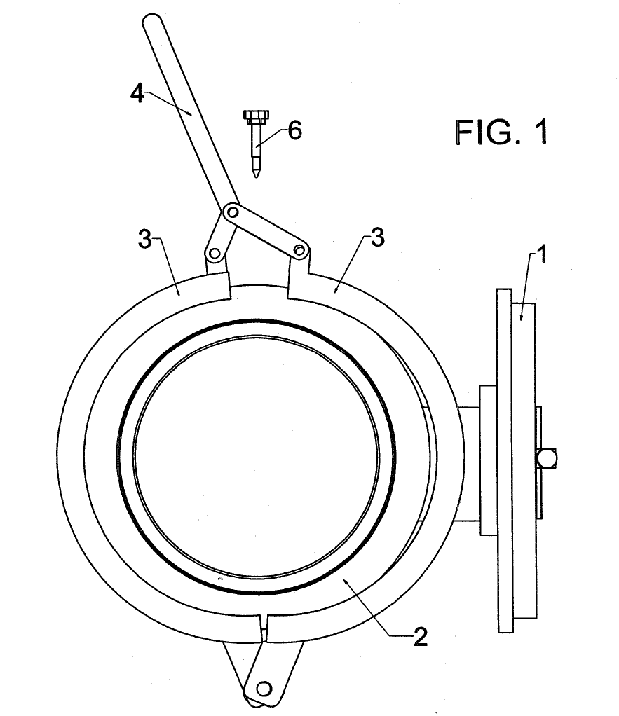

FIG. 1 is a front view of the open lid,

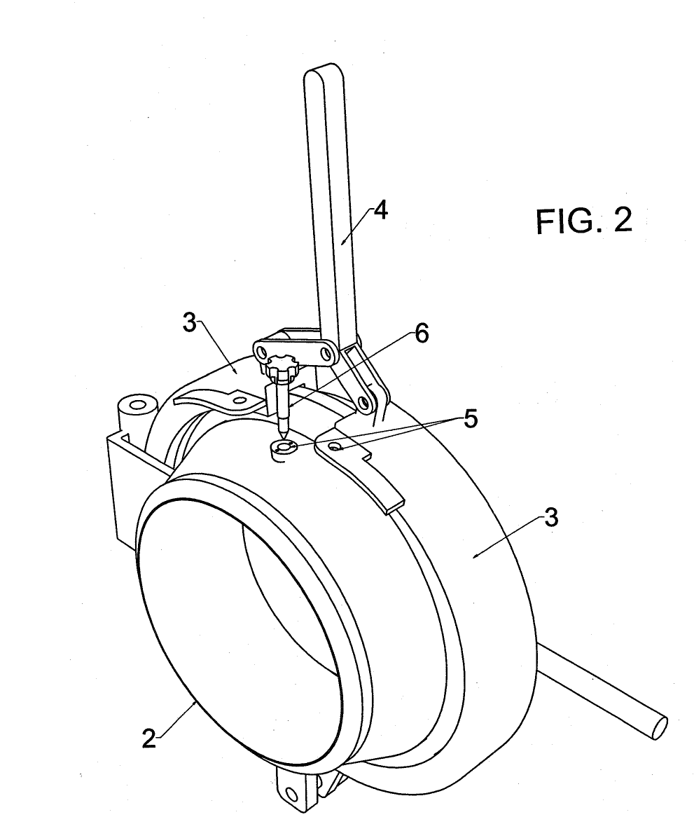

FIG. 2 is a side rear view of the open lid,

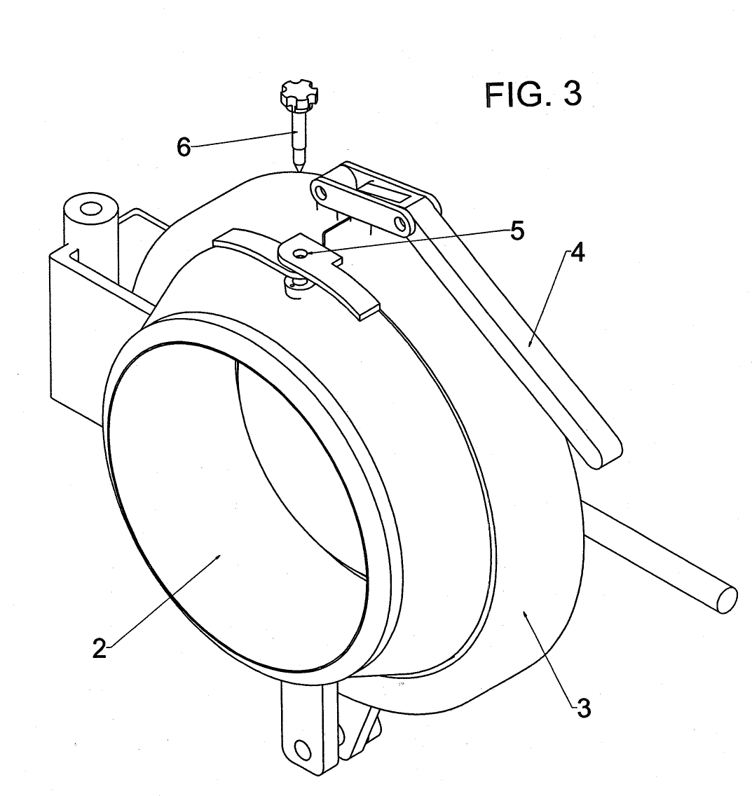

FIG. 3 is a side rear view of the closed lid and

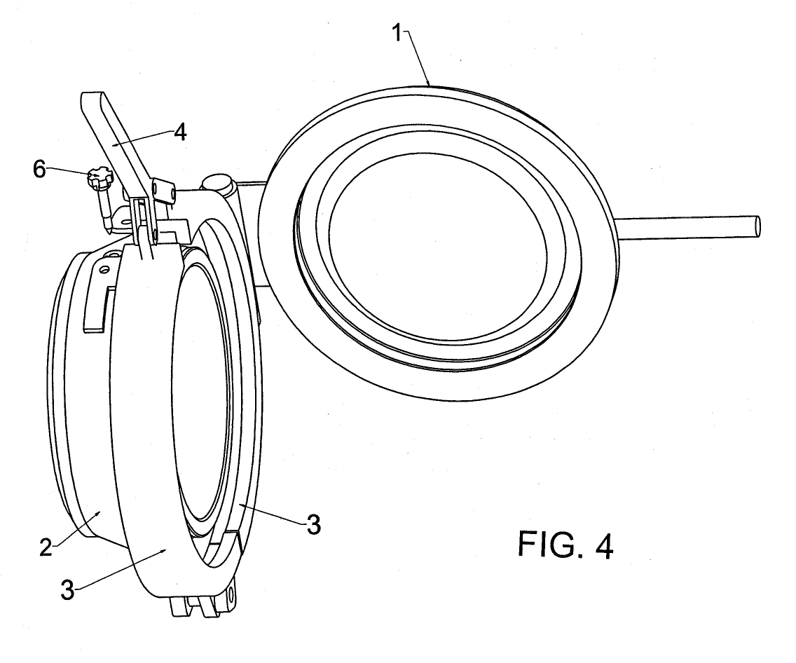

FIG. 4 is a side front view of the open lid.

As inferred from the diagrams, the lid (1) operates freely from equipment that lock it, as they are installed on the mouth (2) of the pressure receptacle itself and consist of two clamps (3), which are closed by a lever (4), which is lowered to bring the two clamps together (3) over the circumference of the mouth (2) of the pressure receptacle and the lid (1), thereby locking them airtight. When the entire assembly is locked, two parts contiguous to the clamps (3) come together, one on top of the other, placing the two holes (5) of the clamps on the same axis as the hole (5) of the upper part of the mouth (2) of the pressure receptacle. When the holes (5) are in the same position forming a single axis, the screw (6), or safety valve, will go through the all holes at one time (5), thereby securing the clamps (3) that hold the lid (1) and preventing the contents of the pressure receptacle from escaping. In order to open the pressure receptacle, first the screw (6) should be turned so that the pressure in the receptacle is relieved and then the screw (6) must be removed to release the entire assembly.

What is claimed is:

1. A quick opening and closing lid for PIG chambers, with a safety valve, comprising:
two clamps connected to each other at one end of each clamp,
a lever connected to opposite ends of the two clamps and which opens and closes the two clamps by moving the opposite ends of the two clamps away and toward each other, respectively,
two parts with orifices mounted contiguous to the opposite ends of the clamps for movement with the opposite ends of the clamps, such that the orifices of the two parts align along a single axis along with an orifice of a mouth of a pressure receptacle clamped by said clamps, when the clamps are in a closed position, and
a pressure lid for closing the mouth of the pressure receptacle.

2. A quick opening and closing lid for PIG chambers, with a safety valve, according to claim 1, further comprising a needle pressure valve which traverses all of said orifices when the lid is closed.

3. A quick opening and closing lid for PIG chambers, with a safety valve, according to claim 2, wherein the needle pressure valve, when loosened, allows pressure inside the receptacle to escape.

4. A quick opening and closing lid for PIG chambers, with a safety valve, according to claim 3, wherein the needle pressure valve, when removed, permits the opposite ends of the two clamps to move away from each other.

5. A quick opening and closing lid for PIG chambers, with a safety valve, according to claim 3, wherein the pressure valve, when installed, secures the opposite ends of the clamps together, to maintain an internal pressure of the receptacle.

6. A quick opening and closing lid for PIG chambers, with a safety valve, according to claim 2, wherein the lid is only allowed to be shut after the safety valve has been closed by positioning the needle valve in all of said orifices.

7. A quick opening and closing lid for PIG chambers, with a safety valve, according to claim 2, wherein the lid is only allowed to open after the safety valve has been removed by removing the needle valve from all of said orifices.
